(19) United States
(12) Patent Application Publication
(10) Pub. No.: US 2023/0182299 A1
(43) Pub. Date: Jun. 15, 2023

(54) ONLINE AUTO-INTERLOCK STRATEGY

(71) Applicant: FANUC CORPORATION, Yamanashi (JP)

(72) Inventors: Hsien-Chung Lin, Fremont, CA (US); Tetsuaki Kato, Fremont, CA (US); Chi-Keng Tsai, Bloomfield Hills, MI (US)

(21) Appl. No.: 17/644,123

(22) Filed: Dec. 14, 2021

(51) Int. Cl. B25J 9/16; B25J 9/00

(52) U.S. Cl. CPC B25J 9/1666; B25J 9/0087

(57) ABSTRACT

A deadlock avoidance motion planning technique for a multi-robot system. The technique includes online calculation of swept volumes for upcoming robot motion segments, and uses the swept volumes to compute one or more overlap zones, which are published to all robot controllers. Swept volume calculation is based on actual upcoming tool path, including adaptive conditions such as jumps and offsets. Robot controllers check at each time step whether an overlap zone will be entered and whether another robot is already in the zone. When a robot determines that it is about to enter a zone that is occupied, the robot holds position until the zone is vacated. Robots publish zone entry and exit for other robots’ awareness. Additional logic is added to establish priority for automatically resolving a deadlock condition, and for prioritizing completion of motion segments for a robot which is performing a continuous processing operation.

### BACKGROUND

### Field

The present disclosure relates generally to the field of industrial robot motion control and, more particularly, to a deadlock avoidance motion planning technique for a multi-robot system which uses swept volumes for upcoming robot motion segments to compute one or more overlap zones, monitors occupancy of each overlap zone by any of the related robots and, when any robot has entered an overlap zone, prevents any others of the related robots from entering the overlap zone until it has been vacated.

### Discussion of the Related Art

The use of industrial robots to perform a wide range of manufacturing, assembly and material movement operations is well known. In many robot workspace environments, two or more robots are operating simultaneously to perform operations such as spot welding, spray painting or conveyor pick-and-place. When two or more robots are working together in a workspace, their motions must be planned and controlled to prevent collisions. Collision avoidance motion planning techniques are known in the art, including robot-to-robot collision avoidance in multi-robot systems.

In addition to collision avoidance, multi-robot systems must attempt to prevent a deadlock condition from occurring. Deadlock in a two-robot system, for example, is when each robot blocks the path of the other robot, such that neither robot can move forward along its planned motion path without causing a collision. When deadlock occurs, at least one of the robots must be moved backwards or re-routed off of its planned path to allow collision-free motion to resume. Deadlock conditions are to be avoided whenever possible, as they result in reduced robot productivity, and may also result in ruined workpieces when operations such as painting or welding are interrupted in an undesirable manner. Interference checking alone cannot prevent deadlock.

Techniques for avoiding deadlock are known in the art, including manual and automated methods. Manually identifying potential deadlock conditions and adding interlocks to the robot motion programs to prevent deadlock is a very tedious and time-consuming method. Automated deadlock-avoidance techniques have therefore been developed, including a method which computes swept volumes and overlap zones offline in advance of execution of a motion program, and inserts overlap zone entry/exit events in the motions programs before execution. This technique is less time-consuming than the manual method, and is effective at preventing deadlock in certain robot motion programs. However, the offline computation of swept volumes and overlap zones cannot properly handle deadlock prevention in motion programs with certain types of motion events - such as tool center point jumps, and when tool center point positions are acquired online during execution via position registers or other techniques.

In light of the circumstances described above, there is a need for an improved deadlock prevention technique which is easy to set up and which prevents deadlock in multi-robot systems including adaptive motion control segments computed online during robot execution.

### SUMMARY

In accordance with the teachings of the present disclosure, a deadlock avoidance motion planning technique for a multi-robot system is disclosed. The technique includes online calculation of swept volumes for upcoming robot motion segments, and uses the swept volumes of individual robots to compute one or more overlap zones, which are published to all robot controllers. Swept volume calculation is based on actual upcoming tool path, including adaptive conditions such as jumps and offsets. At each robot time step, the robot controller checks to see if an overlap zone will be entered and, if so, whether another robot is already in the zone. When a robot determines that it is about to enter a zone that is already occupied, the robot holds position until the zone is vacated by the other robot. Robots publish zone entry and exit events for the awareness of other robots. Additional logic is added to establish priority for automatically resolving an incipient deadlock condition, and for prioritizing completion of motion segments for a robot which is performing a process operation such as painting or welding.

Additional features of the presently disclosed devices and methods will become apparent from the following description and appended claims, taken in conjunction with the accompanying drawings.

### BRIEF DESCRIPTION OF THE DRAWINGS

FIG. 1 is an illustration of a system including two industrial robots working in a common workspace, where interference checking and deadlock prevention are needed;

FIG. 2 is a simplified two-dimensional illustration of a deadlock condition in a two-robot system;

FIG. 3 is a two-dimensional illustration of a manual technique for preventing deadlock by analyzing tool path overlap regions and inserting interlock checkpoints in the robot motions programs, according to a technique known in the art;

FIG. 4 is an illustration of swept volumes for the two robots of FIG. 1, including an overlap region of the swept volumes which indicates a need for deadlock avoidance robot motion planning;

FIG. 5 is a high-level block diagram of a multi-robot system including online interlock definition for deadlock prevention, according to an embodiment of the present disclosure;

FIG. 6 is a block diagram illustrating features of the workspace manager module shown in FIG. 5, according to an embodiment of the present disclosure;

FIG. 7 is a flowchart diagram of a method used by the high level planner module for each of the robots in a multi-robot system as shown in FIG. 5, according to an embodiment of the present disclosure;

FIG. 8 is a flowchart diagram of a method used by the low level interpolator module for each of the robots in a multi-robot system as shown in FIG. 5, according to an embodiment of the present disclosure;

FIGS. 9A-9G are illustrations of a time sequence of overlap zones and events for a three-robot system, according to embodiments of the present disclosure;

FIGS. 10A/10B/10C are progressive illustrations of a two-robot system where a deadlock condition develops even though neither robot moved into an occupied overlap zone;

FIG. 11 is a flowchart diagram of a method used by the low level interpolator module for each of the robots in a multi-robot system as shown in FIGS. 10A-10C, including playback to resolve a deadlock, according to an embodiment of the present disclosure;

FIG. 12 is a flowchart diagram of a method used by the motion planner for each robot which performs a continuous process operation in a multi-robot system, according to an embodiment of the present disclosure;

FIG. 13 is a flowchart diagram of a method used by the high level planner for each robot which performs a continuous process operation in a multi-robot system, according to an embodiment of the present disclosure; and

FIG. 14 is a flowchart diagram of a method used by the low level interpolator for each robot which performs a continuous process operation in a multi-robot system, according to an embodiment of the present disclosure.

### DETAILED DESCRIPTION OF THE EMBODIMENTS

The following discussion of the embodiments of the disclosure directed to deadlock avoidance in robot motion planning is merely exemplary in nature, and is in no way intended to limit the disclosed devices and techniques or their applications or uses.

It is well known to use industrial robots for a variety of manufacturing, assembly and material movement operations. When two or more robots are working together in a workspace, their motions must be planned and controlled to prevent collisions and avoid deadlock.

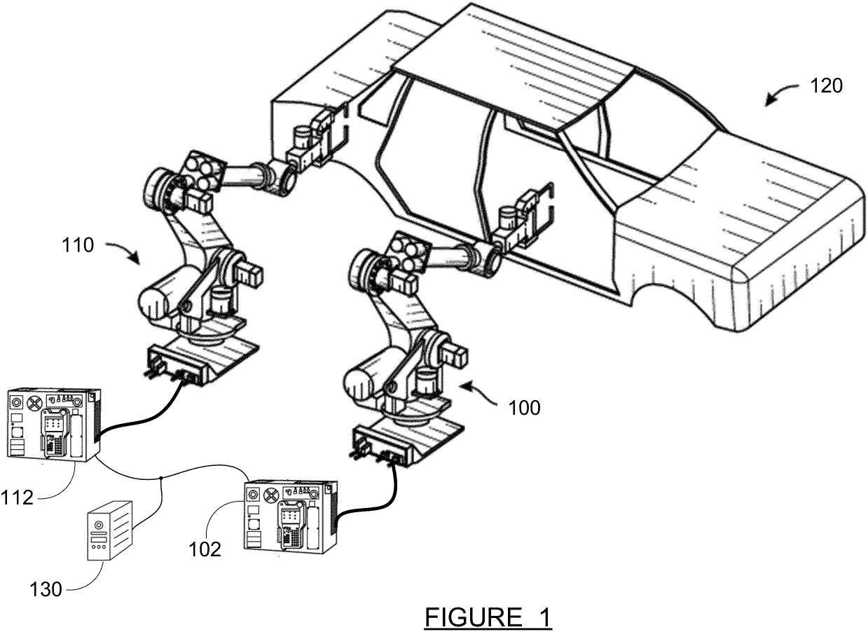

FIG. 1 is an illustration of two industrial robots (100, 110) working near a vehicle body workpiece 120. Motions of the robots 100 and 110 are controlled by a robot controller, as known in the art. The robot 100 has a controller 102, and the robot 110 has a controller 112. Because the motions of the robots 100 and 110 must be coordinated to prevent collisions, the controllers 102 and 112 are in communication with each other. Furthermore, a separate computer 130 may also be provided in communication with the controllers 102 and 112, where the computer 130 could be a programmable logic controller (PLC) or other type of computing device which controls the overall activity of the workcell or workspace in which the robots operate. For example, in a material movement application, the computer 130 could coordinate robot motions relative to the availability and location of inbound parts on a conveyor.

In the workspace of FIG. 1, the robots 100 and 110 are performing spot welding tasks on various locations of the workpiece 120. The spot welding includes locations in the interior of the vehicle body, requiring the robots 100 and 110 to reach inside the door openings. In this application, the vehicle body workpiece 120 is itself an obstacle to the motion of the robots 100 and 110. In addition, the robots 100 and 110 may have overlapping motions, which means that the robots 100 and 110 may be obstacles to each other. Operation of the robots 100 and 110 requires interference check calculations to be performed for all planned motions.

Collision avoidance motion planning techniques are known in the art, including robot-to-robot collision avoidance in multi-robot systems. In addition to collision avoidance, multi-robot systems must attempt to prevent a deadlock condition from occurring. Deadlock is when robots block each other’s paths, such that further robot movement along planned motion paths is not possible without causing a collision. When deadlock occurs, at least one of the robots must be moved backwards or re-routed to allow collision-free motion to resume. Deadlock conditions are to be avoided whenever possible. Interference checking alone cannot prevent deadlock.

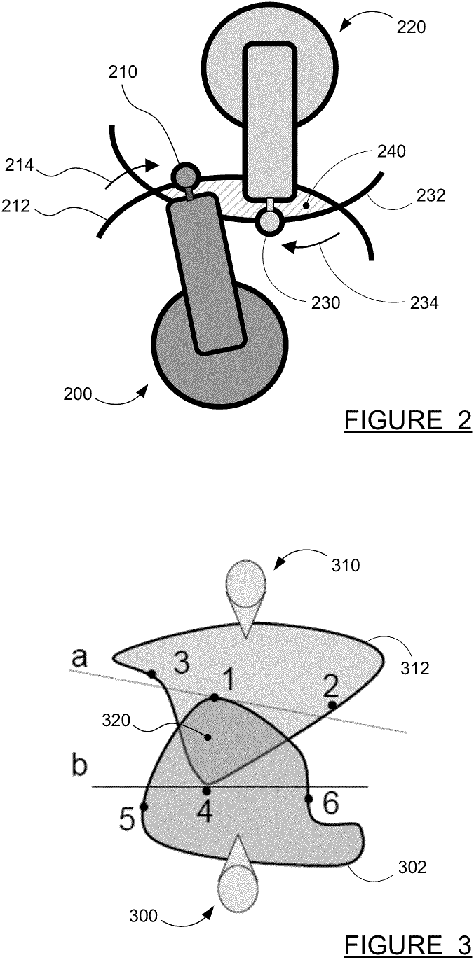

FIG. 2 is a simplified two-dimensional (2D) illustration of a deadlock condition in a two-robot system. A robot 200 and a robot 220 are shown in a top (plan) view as simple robots having a base, a robot arm and a tool or an end-effector. The robot 200 has a tool 210 which is moved along a path 212 in a direction indicated by arrow 214, while the robot 220 has a tool 230 which is moved along a path 232 in a direction indicated by arrow 234. A deadlock condition exists in FIG. 2, because neither the robot 200 nor the robot 220 can move its tool further along its path without causing a collision. Essentially, deadlock became inevitable once both the robot 200 and the robot 220 entered an overlap region 240, which is the area between the path 212 and the path 232. As would be understood by one skilled in the art, one robot (e.g., the robot 220) can enter the overlap region 240 and continue to move its tool along its path as long as the other robot (the robot 200) remains outside the overlap region 240.

Once both robots enter the overlap region 240, a deadlock condition exists, and the only solution is for one of the robots to reverse course (“back up”) or otherwise reroute its tool. This is obviously not a desirable situation. Techniques for preventing or avoiding deadlock are known in the art, including manual and automated methods.

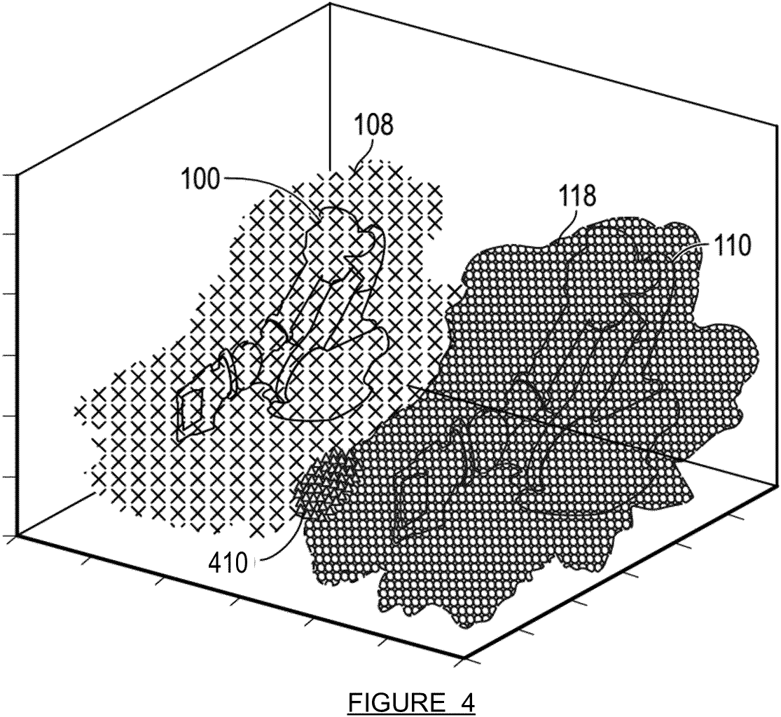

FIG. 3 is a two-dimensional illustration of a manual technique for preventing deadlock by analyzing tool path overlap regions and inserting interlock checkpoints in the robot motions programs, according to a technique known in the art. A robot 300 and a robot 310 each include multi-link robot arms and a tool, and are illustrated in simplified form in a top view, in the manner discussed above with respect to FIG. 2. The robot 300 has a tool which traces a tool path 302, and the robot 310 has a tool which traces a tool path 312. An overlap region 320 exists in the intersection space between the tool path 302 and the tool path 312. A known method for avoiding deadlock is to add interlocks, or checkpoints, into the motion programs of the robots 300 and 310. When a robot reaches an interlock in its motion program, it checks the status of the other robot before proceeding.

One manual technique for adding the checkpoints is shown in FIG. 3. A point 1 is identified as the point along the tool path 302 which is closest to the robot 310. A point 4 is identified as the point along the tool path 312 which is closest to the robot 300. A line “a” is then drawn - such as perpendicular to a line from the point 1 to the base of the robot 310. Interlock points 2 and 3 are then added to the motion program of the robot 310. Similarly, a line “b” is drawn perpendicular to a line from the point 4 to the base of the robot 300. Interlock points 5 and 6 are added to the motion program of the robot 300.

If the robot 310 moves its tool along the tool path 312 in a clockwise direction, then when the tool reaches the interlock point 2, the robot 310 checks the status of the robot 300 before proceeding. The robot 310 proceeds along its tool path 312 only if the robot 300 is known to be clear of the overlap region 320. When the robot 310 proceeds past the interlock point 2, it reports that it has effectively entered the overlap region 320, so that the robot 300 knows to remain clear. When the robot 310 moves along the tool path 312 and reaches the interlock point 3, it reports that it has exited the overlap region 320, so that the robot 300 may enter. The robot 300 uses the interlock point 5 to check before entering the overlap region 320 and then report entry, and the interlock point 6 to report exiting the overlap region 320.

Even in the simplified 2D illustration of FIG. 3, it can be seen that manually adding interlock points to the robot motion programs requires extra work. The technique also creates inefficiency due to the conservative simplifications used in defining the interlock points, as the robots will be required to hold position more than is necessary to actually remain clear of the overlap region 320.

FIGS. 2 and 3 are illustrated in two dimensions to maintain visual clarity. In actual robot operations, the spaces occupied by each robot and the overlap regions of the spaces are complex three-dimensional (3D) shapes. However, the concept of preventing multiple robot occupancy of an overlap region applies in 3D space in the same way as illustrated in FIGS. 2 and 3. This is discussed below.

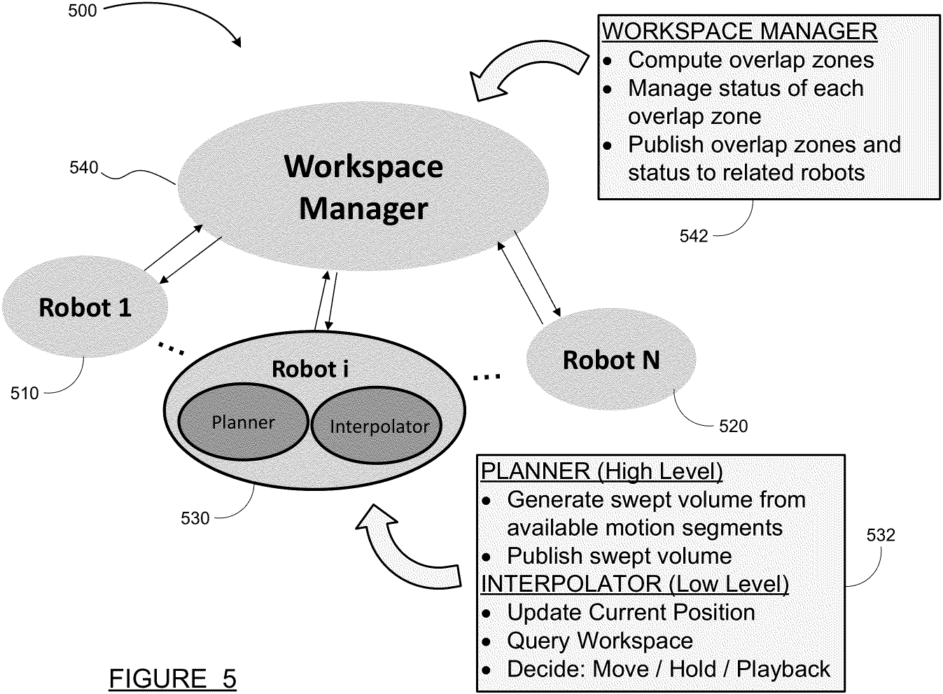

FIG. 4 is an illustration of swept volumes for the two robots of FIG. 1, including an overlap region of the swept volumes which indicates a need for deadlock avoidance robot motion planning. FIG. 4 shows the robots 100 and 110 from an opposite viewing perspective from FIG. 1. The robots 100 and 110 are outlined in their home positions in FIG. 4. Swept volumes 108 and 118 are computed using any suitable technique. The swept volume 108 is the volume which is occupied at some point in the motion program of the robot 100, and the swept volume 118 is the volume which is occupied at some point in the motion program of the robot 110. Typically, robot swept volume computation begins with a 3D geometric model (such as a CAD model) of each component of each robot, and incrementally adds to a cumulative volume envelope as the robot moves through steps of its motion program. Techniques for computing a robot swept volume are known in the art - including techniques which use voxels (cube or brick shaped volume elements) to represent occupied volume, and other techniques.

An overlap volume 410 is the space which is within (common to) both the swept volume 108 and the swept volume 118. Although the overlap volume 410 does not necessarily indicate that a collision will occur, because the robots 100 and 110 may occupy that portion of their swept volumes at different times, the presence of the overlap volume 410 indicates that collision avoidance interference checking must be performed during robot operation, and also indicates that a deadlock condition is possible and deadlock avoidance should also be included in the robot motion programming.

FIG. 4 illustrates the complexity of the 3D geometry involved in real robot swept volumes and overlap zones, and the difficulty of applying the manual method shown in FIG. 3 to such complex 3D geometry. Automated deadlock-avoidance techniques have therefore been developed, including a method which computes swept volumes and overlap zones offline in advance of execution of a motion program, and inserts overlap zone entry/exit interlocks in the motion programs before execution. This technique is less time-consuming than the manual method of FIG. 3, and is effective at preventing deadlock in certain robot motion programs. However, the offline computation (before robot operations) of swept volumes and overlap zones cannot properly handle deadlock prevention in adaptive motion programs with certain types of motion events - such as tool center point jumps, and when tool center point positions are acquired online during execution via position registers or other techniques.

The present disclosure provides a deadlock prevention technique which is performed entirely online during robot operation. The technique accurately computes swept volumes and overlap zones even for motion programs in which the tool path is affected by adaptive events such as jumps and position register offsets which are resolved in real time.

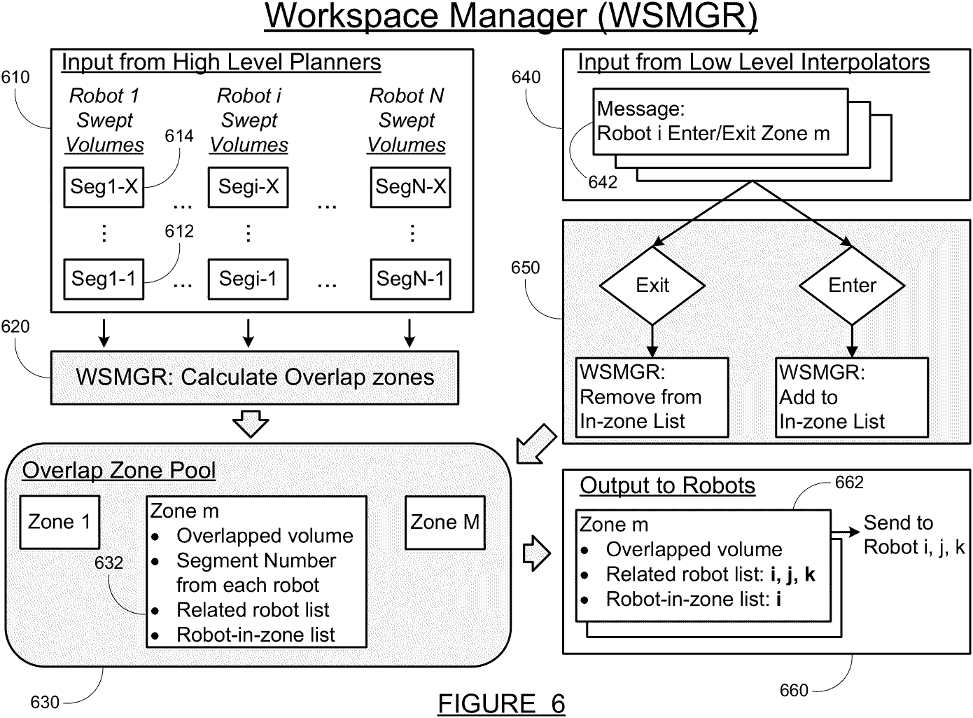

FIG. 5 is a high-level block diagram of a multi-robot system 500 including online interlock definition for deadlock prevention, according to an embodiment of the present disclosure. The system 500 includes at least two robots operating in a common workspace. The example illustrated in FIG. 5 includes “N” robots, including a Robot 1 identified by reference number 510, a Robot N identified by reference number 520 and a Robot “i” identified by reference number 530. The Robot “i” will be referred to as the robot 530, and is representative of all of the robots in the system 500. Each of the robots 510/520/530 includes the robot itself and a robot controller, in the manner illustrated in FIG. 1. A single robot controller may also control more than one robot.

A workspace manager module 540 is a software module which communicates with the controller of each of the robots 510/520/530. The workspace manager module 540 could run on the controller of one of the robots, or it could run on a separate computer such as the computer 130 shown in FIG. 1. The workspace manager module 540 keeps track of overlap zones and robot occupancy of the zones in real time, according to the presently disclosed techniques.

The actions and interactions of the robot 530 and the workspace manager module 540 are discussed at a high level with respect to FIG. 5, and in further detail below. It is to be understood that each of the robots 510/520/530 interacts with the workspace manager module 540 in the same manner. The controller of the robot 530 performs motion planning functions shown in a box 532, including a high level motion planner and low level motion interpolator function. As outlined in the box 532, the high level planner generates a swept volume from available upcoming motion segments for the robot 530. A motion segment is a command in the robot motion program, such as “move in a straight line to point P77”. Many different types of robot motion commands are available for motion programming, as known by those skilled in the art. Because of adaptive motion programming features such as jumps and position registers, it is often not possible to calculate the entire motion program in advance. However, at some point, the position registers become populated and other adaptive features such as jumps are resolved, and some number of upcoming motions segments become definite. For example, if the next two motion segments are definite, then the high level planner will compute a swept volume for those next two motion segments.

The techniques of the present disclosure involve the computation of swept volumes for individual robot motion segments, and the computation of overlap zones which are the intersection of two or more swept volumes. It is to be understood that any suitable method for computing the swept volumes and overlap zones may be used.

The high level planner sends or publishes computed swept volumes to the workspace manager module 540. The workspace manager module 540 computes overlap zones occurring between the swept volumes of all of the robots 510-530 in the system. At some points in time, there may be no overlap zones between the swept volumes, as the robots are each working in separate parts of the workspace. At other points in time, there may be two or more overlap zones between the swept volumes of the robots, such as zones involving different pairs of robots. The workspace manager module 540 publishes active overlap zones to all of the robots that are involved in each overlap zone. Along with publishing the 3D geometric shape of each overlap zone, the workspace manager module 540 continuously publishes the identity of the robots involved in each zone, and the identity of any robot which currently occupies each overlap zone.

Returning to the robot 530 - the low level interpolator computes the actual robot motion (joint commands) for each upcoming time step in the current motion segment. Before moving the robot, the low level interpolator queries the workspace to determine if the impending motion will cause the robot to enter an overlap zone that was published by the workspace manager module 540. If the impending motion will cause the robot to enter an overlap zone, the robot controller determines whether another robot already occupies the overlap zone. If another robot already occupies the overlap zone, then the controller does not move the robot - that is, the controller causes the robot to hold in its current position so as to avoid a deadlock condition from two robots simultaneously occupying an overlap zone. If another robot does not already occupy the overlap zone, then the controller moves the robot according to the time step joint commands computed by the low level interpolator. Upon entering an overlap zone, the interpolator module also publishes the entry to the workspace manager module 540 which is keeping track of occupancy as discussed above. The interpolator module also publishes overlap zone exit events to the workspace manager module 540.

The process described above continues throughout the operation of the robots as they perform their tasks (e.g., welding, spray painting, etc.). Each robot computes swept volumes for available upcoming motion segments; the workspace manager module 540 computes overlap zones from the robots’ swept volumes, tracks occupancy of the overlap zones and publishes the zones and their status; and each robot checks overlap zone status before each time step (or interpolation point) of motion, to ensure it does not enter an occupied overlap zone. Additional features and capabilities of the disclosed techniques are discussed below.

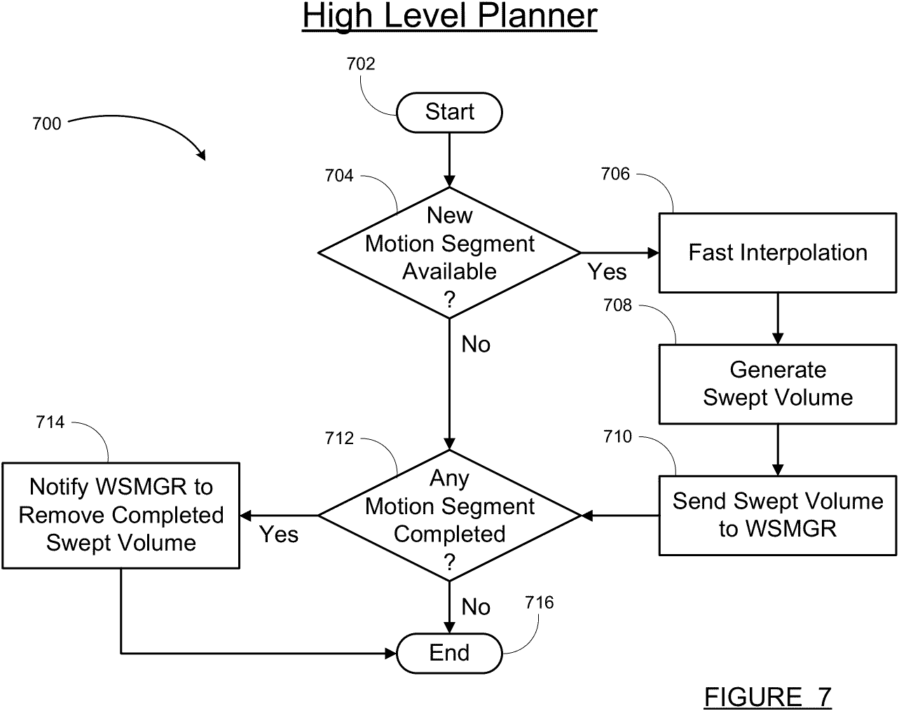

FIG. 6 is a block diagram illustrating features of the workspace manager module 540 shown in FIG. 5, according to an embodiment of the present disclosure. FIG. 6 shows inputs to the workspace manager, calculations by the workspace manager and the resulting data, and outputs from the workspace manager.

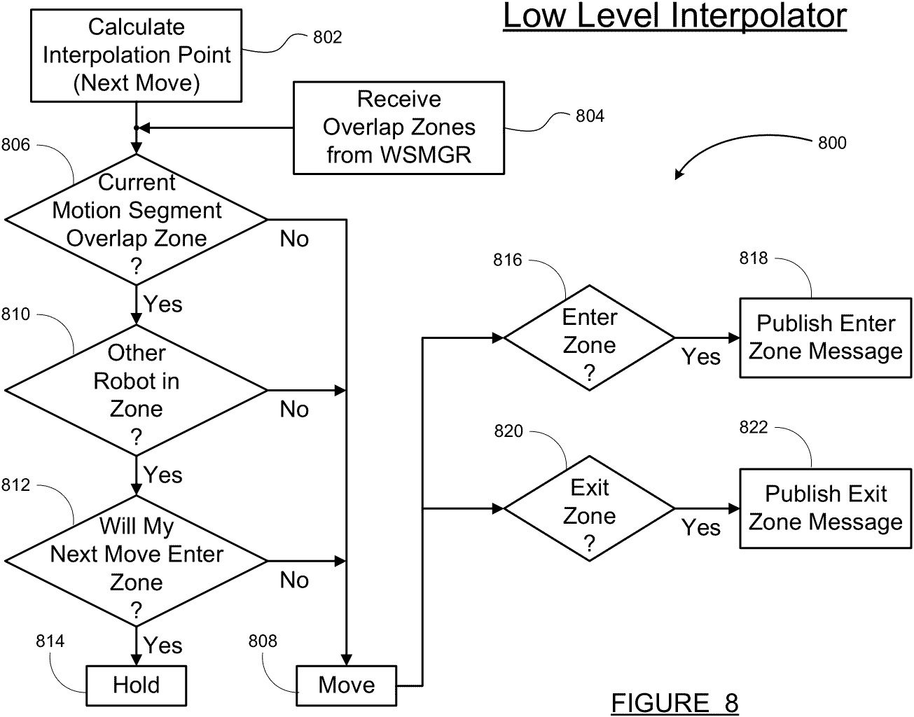

Box 610 depicts inputs received by the workspace manager from the high level planner modules of the robots in the system (e.g., the robots 510/520/530 of FIG. 5). Each robot publishes a swept volume for each motion segment which is available and definite, as discussed earlier. In the box 610, as in FIG. 5, the robots “i” are numbered 1 through N. For example, beginning with a first motion segment, the first robot publishes a swept volume 612 labeled as “Seg1-1”, indicating it is from Robot 1 and it is motion segment number 1. Robot 1 continues to publish swept volumes up through a swept volume 614 labeled as “Seg1-X”, indicating it is from Robot 1 and it is motion segment number “X”. Each of the N robots similarly publishes a swept volume for each motion segment when it becomes available, with each swept volume labeled with the robot number and the motion segment number. Each of the robots also sends a message to the workspace manager when one of the previously published swept volumes (such as “Seg1-1” or 612) has been completed. The process used by each robot’s high level planner to send swept volume data is shown in FIG. 7.

In one preferred embodiment, each swept volume includes the robot motion for one motion segment. In another embodiment particularly suitable for robots performing continuous processes such as spray painting, laser/arc welding or material dispensing, a robot publishes a single swept volume defining the robot motion for all of the motion segments contained in the continuous process, because all of the motion segments need to be completed without interruption. This embodiment is discussed further below.

All of the available swept volumes from the robots (the box 610) are provided to the workspace manager at box 620, where overlap zones between the swept volumes are calculated. Again it is emphasized that the publishing of swept volumes by the robot controllers continues in real time throughout the operation of the robots. Each robot controller publishes its swept volumes independently as motion segments become available (definite). As shown in FIG. 4, each overlap zone is defined by the intersection of two or more swept volumes. The overlap zones are typically irregularly shaped 3D volumes, and may be defined by voxels (cubic or brick-shaped volume elements) or by other 3D solid or surface geometry definition techniques.

The overlap zones from the box 620 are provided to an overlap zone pool 630 where they are managed by the workspace manager. The overlap zone pool 630 is shown to include overlap zones ranging from numbers 1 through M. A representative overlap zone “m” (632) shows what information is managed for each overlap zone - including 3D definition of the overlapped volume, the segment number from each robot which is involved in the overlap zone, a list of related robots (robots which have a segment involved in the overlap zone), and a list of robots (if any) currently in the overlap zone.

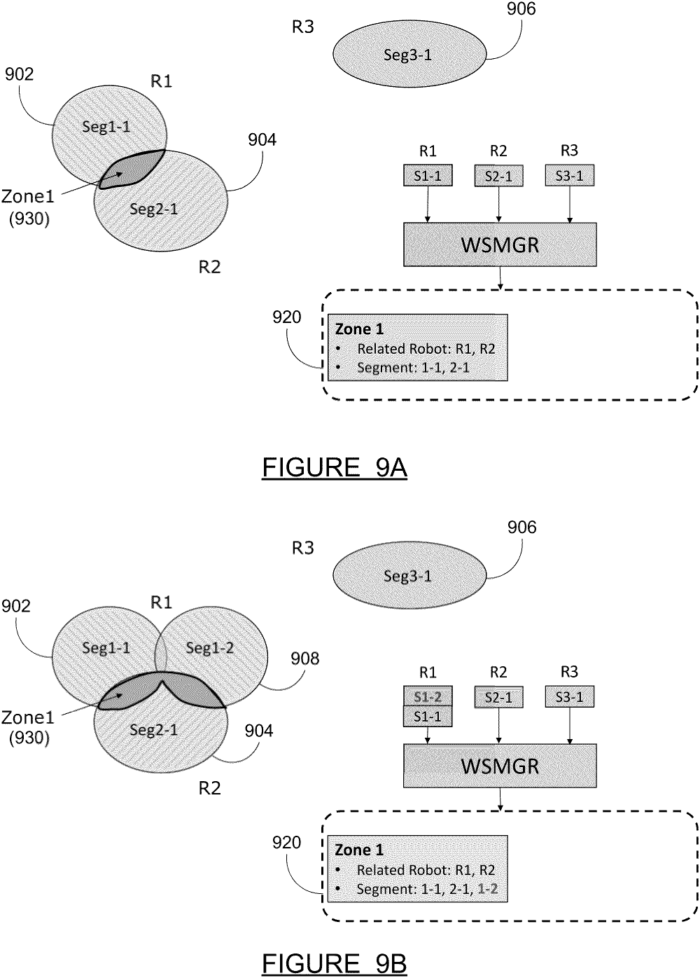

Box 640 depicts inputs received by the workspace manager from the low level interpolator modules of the robots in the system. In addition to the low level interpolator’s responsibility for ensuring the robot does not enter an already-occupied overlap zone, the interpolator also publishes messages indicating when the robot has entered or exited a particular overlap zone. A message 642 is shown which states that Robot “i” has entered (or exited) Overlap Zone “m”. The process used by each robot’s low level interpolator to send swept volume data is shown in FIG. 8.

The messages 642 are used by the workspace manager at box 650 to update the overlap zone data in the overlap zone pool 630. If an “exited zone” message is received by the workspace manager at the box 650, the workspace manager removes Robot “i” from the Robot-in-zone list for Overlap Zone “m”. Similarly, if an “entered zone” message is received by the workspace manager at the box 650, the workspace manager adds Robot “i” to the Robot-in-zone list for Overlap Zone “m”.

At box 660, whenever an overlap zone in the overlap zone pool 630 is added, eliminated, or has a status change, the affected overlap zone is published (output) to the affected robots. For example, consider a zone publication message 662 for the overlap zone “m”, where the zone “m” was previously published with its overlapped volume to the related robots (i, j and k) and their respective motion segment numbers. The zone publication message 662 adds the robot “i” to the Robot-in-zone list, which is important information for all of the related robots to know, as will be discussed below. Examples of other zone publication messages include a later message which indicates that the robot “i” has exited the zone “m” (so the Robot-in-zone list is empty), and a still later message which indicates that the zone “m” no longer exists based on the latest swept volumes received from the robots.

FIG. 7 is a flowchart diagram 700 of a method used by the high level planner module for each of the robots in a multi-robot system as shown in FIG. 5, according to an embodiment of the present disclosure. From a start block 702, the method proceeds to a decision diamond 704 where it is determined whether a new motion segment is available. A new motion segment is a motion segment which has not previously been included in a swept volume published by the robot, and the new motion segment is now fully defined (for example, tool center point jumps have been resolved and position register data is now available). As discussed earlier, the ability to handle motion segments incrementally in adaptive motion programs, during real-time robot execution, is an important feature of the presently disclosed techniques.

If a new motion segment is available, then at box 706 a fast interpolation is performed to provide the robot motions for the motion segment. The fast interpolation may, for example, compute an entire motion segment using the start and end points and few if any intermediate interpolation points, and also without performing all joint motion smoothness optimization calculations. At box 708, a swept volume is generated for the motion segment which was computed at the box 706. At box 710, the swept volume from the box 708 is sent to the workspace manager, where it is received at the box 610 as shown on FIG. 6.

Decision diamond 712 is reached after the swept volume is sent at the box 710, or when no new motion segment is available at the decision diamond 704. At the decision diamond 712, it is determined whether any motion segment has been completed. If so, then at box 714 the high level planner sends a message to the workspace manager dictating that the swept volume for the completed motion segment should be removed from any/all overlap zones in the overlap zone pool. Any overlap zones which are affected (changed or eliminated) by the removal of the swept volume will be re-published. The high level planner process ends at terminus 716 after any swept volume removal notifications are sent.

FIG. 8 is a flowchart diagram 800 of a method used by the low level interpolator module for each of the robots in a multi-robot system as shown in FIG. 5, according to an embodiment of the present disclosure. At box 802, a next move interpolation point is calculated. As known in the art, interpolation points are calculated by a robot’s motion system at a plurality of locations along a motion segment. Each interpolation point prescribes a next move of the robot defined by joint motion commands sent from the controller to the robot. At box 804, the low level interpolator in the robot controller receives the overlap zones published by the workspace manager. These are the zone publication messages 662 shown in FIG. 6 and discussed above.

At decision diamond 806, it is determined whether the current motion segment (which is being interpolated by the low level interpolator) is involved in an overlap zone published by the workspace manager. If not, then the low level interpolator instructs the robot to move to the computed interpolation point at box 808. If the current motion segment is involved in an overlap zone, then at decision diamond 810 it is determined whether any other robot is currently in the overlap zone. This information is available from the Robot-in-zone list in the zone publication messages from the workspace manager. If no other robot is currently in the overlap zone, then the low level interpolator instructs the robot to move at the box 808.

If any other robot is currently in the overlap zone, then at decision diamond 812 it is determined whether the next move (the computed interpolation point) will cause the robot to enter the overlap zone. If so, then in order to prevent a deadlock condition from occurring, the low level interpolator instructs the robot to hold position at box 814. If the next move (the computed interpolation point) will not cause the robot to enter the overlap zone, then the low level interpolator instructs the robot to move at the box 808. The elements 806-814 discussed above can all be implemented as interlocks in the robot motion program, causing the robot to hold position if necessary to avoid deadlock.

When a move is performed at the box 808, the process then proceeds to determine whether an overlap zone has been entered or exited. At decision diamond 816, if the just-completed move caused the robot to enter an overlap zone, then at box 818 the low level interpolator publishes an “entered zone” message to the workspace manager. This was shown in FIG. 6, where an enter/exit zone message 642 from a low level interpolator was received by the workspace manager at the box 650, and the workspace manager used the information to update the Robot-in-zone list for the relevant overlap zone. At decision diamond 820, if the just-completed move caused the robot to exit an overlap zone, then at box 822 the low level interpolator publishes an “exited zone” message to the workspace manager, where it is also handled as shown on FIG. 6.

To summarize the above discussion - FIG. 5 shows the high-level interaction of the workspace manager and the robots in the system. FIG. 6 shows the details of the workspace manager, including inputs from and outputs to the robot controllers. FIGS. 7 and 8 show the methods used by the high level planner and the low level interpolator modules, respectively, of the robot controllers - including inputs from and outputs to the workspace manager.

Throughout the preceding and following discussion, it is to be understood that the “next move” which is evaluated by the low level interpolator is not necessarily just a single step or interpolation point, but may be any increment of upcoming robot motion (such as the next three interpolation points of joint motion).

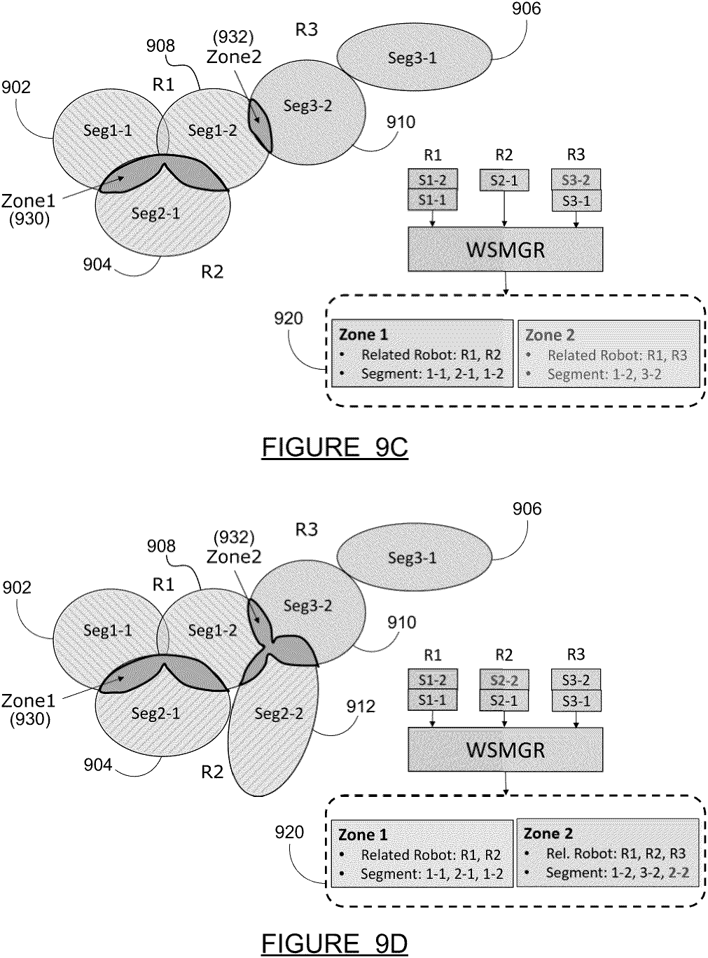

FIGS. 9A-9G are illustrations of a time sequence of overlap zones and events for a three-robot system, according to embodiments of the present disclosure. FIGS. 9A-9G provide a clear depiction of how overlap zones evolve over time (i.e., appear, change shape, and disappear), and are managed accordingly, in a multi-robot system. FIGS. 9A-9G are illustrated in two dimensions in order to maintain visual clarity. It should be understood, however, that the swept volumes and overlap zones are actually three-dimensional in nature as illustrated in FIG. 4.

In FIG. 9A, a robot R1 publishes a swept volume 902 labelled as “Seg1-1”, a robot R2 publishes a swept volume 904 labelled as “Seg2-1”, and a robot R3 publishes a swept volume 906 labelled as “Seg3-1”. The swept volumes Seg1-1, Seg2-1 and Seg3-1 are shown in simplified geometric form in the upper/left portions of FIG. 9A, and are shown in block diagram form (using simplified notation such as S1-1, etc.) at the lower/right portion of FIG. 9A where they are published by their respective robots to the workspace manager (WSMGR), which uses the latest swept volume data to update overlap zones in overlap zone pool 920. An overlap zone “Zone 1” is formed by the intersection of the swept volumes Seg1-1 and Seg2-1, as indicated geometrically by reference numeral 930. Data about the Zone 1 - including the related robots and the involved motion segments - is shown in the overlap zone pool 920. The Robot-in-zone list is not shown in FIGS. 9A-9G, but this piece of data is easily understood as it relates to each zone in the overlap zone pool 920.

In FIG. 9B, the robot R1 publishes a new swept volume 908 labelled as “Seg1-2”, as shown in the geometric depiction and in the block diagram. The addition of Seg1-2 from robot R1 causes a larger overlap zone between motions of robots R1 and R2. Thus, the overlap Zone 1 (930), recalculated by the workspace manager, has increased in size as shown. Note that a new overlap zone is not created, because the Zone 1 already existed and has just been modified. Based on this event (R1 publishing the new swept volume Seg1-2), the workspace manager would re-publish overlap Zone 1 because the geometric definition of the zone has changed, and the involved motion segments list has changed, as shown in the overlap zone pool 920. Further note that the overlap of Seg1-1 with Seg1-2 does not create an overlap zone, because these two swept volumes are both from robot R1.

In FIG. 9C, the robot R3 publishes a swept volume 910 labelled as “Seg3-2”, as shown in the geometric depiction and in the block diagram. The addition of Seg3-2 from robot R3 causes a new overlap zone “Zone 2” to be created between motions of robots R1 and R3. Zone 2 is shown in the geometric depiction (932) and in the block diagram in the overlap zone pool 920. The existing Zone 1 is not affected by the creation of Zone 2. Based on this event (R3 publishing swept volume Seg3-2), the workspace manager would publish Zone 2 with its geometric definition, list of related robots and involved motion segments, but would not re-publish overlap Zone 1 because nothing related to this zone has changed.

In FIG. 9D, the robot R2 publishes a swept volume 912 labelled as “Seg2-2”, as shown in the geometric depiction and in the block diagram. The addition of Seg2-2 from robot R2 causes the Zone 2 (932) to have a significantly different geometric shape, as shown in the illustration. The Zone 2 also now includes a revised list of related robots and involved motion segments, as shown in the geometric depiction and in the block diagram in the overlap zone pool 920. The existing Zone 1 is not affected by the changes to Zone 2. Based on this event (R2 publishing swept volume Seg2-2), the workspace manager would re-publish Zone 2 with its revised geometric definition, revised list of related robots and updated involved motion segments. Again, Zone 1 would not be re-published because nothing related to this zone has changed.

In FIG. 9E, the robot R1 publishes the completion of the swept volume “Seg1-1” (902), as shown in the geometric depiction and in the block diagram. The completion of Seg1-1 by robot R1 causes the Zone 1 (930) to have a significantly different geometric shape, as shown in the illustration. The Zone 1 also now includes a revised list of involved motion segments, as shown in the geometric depiction and in the block diagram in the overlap zone pool 920. The existing Zone 2 is not affected by the changes to Zone 1. Based on this event (R1 publishing the expiration of swept volume Seg1-1), the workspace manager would re-publish Zone 1 with its revised geometric definition and revised list of involved motion segments. Zone 2 would not be re-published because nothing related to this zone has changed.

In FIG. 9F, the robot R2 publishes the completion of the swept volume Seg2-1 (904), and the robot R3 publishes the completion of the swept volume Seg3-1 (906), as shown in the geometric depiction and in the block diagram. The completion of Seg2-1 by robot R2 causes the Zone 1 (930) to be eliminated, as shown in the geometric depiction and in the block diagram in the overlap zone pool 920. The existing Zone 2 is not affected by the completion of the swept volume Seg2-1 or the completion of the swept volume Seg3-1. Based on this event (the expiration of swept volumes Seg2-1 and Seg3-1), the workspace manager would publish the elimination of Zone 1. Zone 2 would not be re-published because nothing related to this zone has changed.

In FIG. 9G, each of the robots R1/R2/R3 publishes the completion of their swept volume remaining from FIG. 9F (Seg1-2, Seg2-2 and Seg 3-2), and each of the robots R1/R2/R3 publishes a new swept volume (Seg1-3, Seg2-3 and Seg 3-3). As shown in the geometric depiction and in the block diagram, Zone 2 disappears with the completion of all of its involved swept volumes, and no new overlap zones are created because there is no overlap between the newly published swept volumes. Thus, the workspace manager would publish the elimination of Zone 2.

The process illustrated in FIGS. 9A-9F would continue with the publication of new swept volumes by the robots, and the appearance, disappearance and modification of overlap zones handled by the workspace manager, until the motion programs of the robots have been completed. The workspace manager can handle publication of a new swept volume from more than one robot at a given time step, publication of multiple swept volumes from a single robot at a time step, etc., in any combination. Throughout all of this, the robots use the overlap zone information to avoid entering an occupied overlap zone, thereby preventing deadlock conditions from occurring.

The online interlock insertion techniques disclosed above -illustrated in the flowchart and block diagrams of FIGS. 5-8 including the workspace manager and its inputs from and outputs to the robot controllers, and depicted in the overlap zone time sequence of FIGS. 9A-9F - have been demonstrated to successfully prevent deadlock conditions in robot motion programs which cannot be analyzed in advance due to adaptive motion events. The techniques are effective - causing a robot to hold position when necessary to avoid entering an occupied overlap zone. The techniques are also efficient - able to be computed in real time without causing slowdown of robot operations due to computation.

However, under certain conditions, a deadlock situation may still occur when using the technique disclosed above - due to an overlap zone changing when one robot publishes a new motion segment swept volume and another robot already occupies part of the space of the updated overlap zone. This situation, and a solution to it, are discussed below.

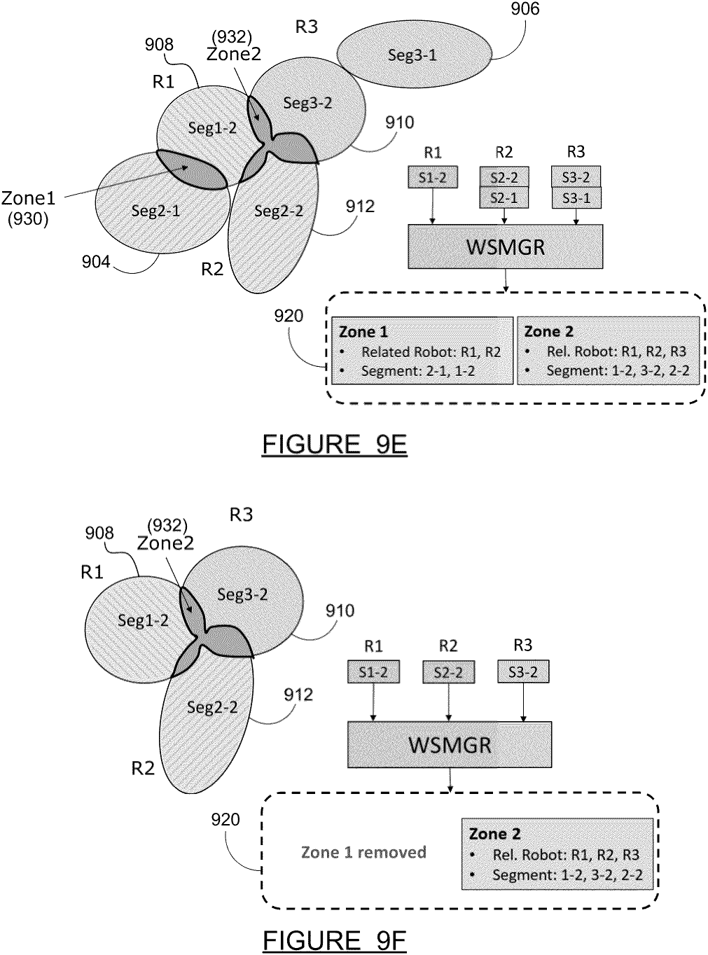

FIGS. 10A/10B/10C are progressive illustrations of a two-robot system where a deadlock condition develops even though neither robot moved into an occupied overlap zone. A robot 1000 and a robot 1010 are shown in a top (plan) view as simple robots having a base, a robot arm and a tool or end-effector, in the same manner discussed previously with respect to FIG. 2. The robot 1000 has a tool which is moved along a path 1002 (from right to left in a straight line), while the robot 1010 has a tool which is moved along a path 1012 (from left to right in a boomerang shape). The robots 1000 and 1010 have each published a swept volume for an upcoming motion segment, and the workspace manager has computed an overlap zone 1020 as shown.

In FIG. 10A, neither of the robots 1000/1010 have moved yet, and both of the robots 1000 and 1010 remain outside of the overlap zone 1020. In FIG. 10B, both the robots 1000 and 1010 have moved along their respective path. The robot 1010 is now inside the overlap zone 1020. The robot 1000 remains outside of the overlap zone 1020, and cannot move further along its path because the next movement would put the robot 1000 into an occupied overlap zone.

In FIG. 10C, neither of the robots 1000/1010 have moved further from FIG. 10B. However, the robot 1010 has published a new motion segment swept volume, which has caused the overlap zone 1020 to move to a new position shown as overlap zone 1020A. Even though the robot 1000 did not move into an occupied overlap zone, it now finds itself inside the overlap zone 1020A along with the robot 1010. A deadlock condition now exists, as neither of the robots 1000/1010 can move further along their path without causing a collision.

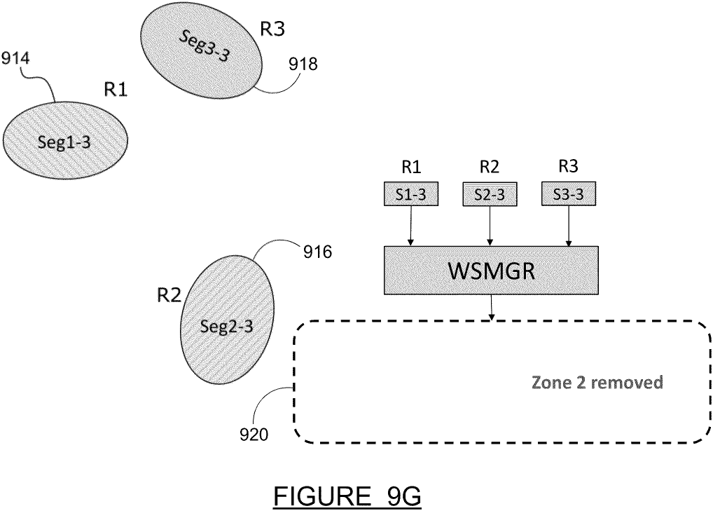

FIG. 11 is a flowchart diagram 1100 of a method used by the low level interpolator module in the controller of each robot in a multi-robot system as shown in FIGS. 10A-10C, according to an embodiment of the present disclosure. The low level interpolator method of FIG. 11 is the same as the low level interpolator method of FIG. 8 discussed previously, except for elements 1110-1116 (shaded) which have been added in FIG. 11. All of the element steps of FIG. 8 retain their original numbering, and will not be discussed further here.

A new decision diamond 1110 is added after the decision diamond 810. In the case where another robot is in the overlap zone (“Yes” at the decision diamond 810), the decision diamond 1110 determines whether the robot itself (the robot on which this low level interpolator method is running) is also in the overlap zone. This situation could happen if the overlap zone geometry changed due to the other robot publishing a new motion segment swept volume, as illustrated in FIG. 10C.

If the robot is in the overlap zone at the decision diamond 1110, then at box 1112 the overlap zone as defined by the previous swept volume is checked. At decision diamond 1114, the robot determines if it was in the overlap zone from the previous swept volume. If not, then at box 1116 the robot “plays back” or moves one step backward along its motion path. This action is taken because, if the robot is not in the overlap zone from the previous swept volume, this means that the publication of an updated overlap zone must have caused the double occupancy of the zone. In the example of FIGS. 10A-10C, the play back at the box 1116 would cause the robot 1000 to move back to its position as shown in FIG. 10A, which would enable the robot 1010 to make its next move to the end of its motion path, after which the robot 1000 could move along the entirety of its motion path.

If, at the decision diamond 1114, the robot determines that it was in the overlap zone from the previous swept volume, then at the box 814 the robot holds its position rather than play back. In this situation, the other robot involved in the overlap zone — using the same logic — may find that it can play back, which would resolve the deadlock situation as discussed above.

The deadlock situation shown in FIGS. 10A-10C arose because the robot 1010 published a new motion segment swept volume after the robot 1000 had already moved into a vulnerable position. This sort of late publishing of motion segments can happen in robot motion programs with adaptive features (e.g., jumps, position registers), as discussed earlier. The method of FIG. 11 provides a technique for automatically resolving deadlock situations which occur due to this sort of late publishing of motion segments, where the automatic deadlock resolution keeps the robots operating with only a minor setback of one robot. The automatic deadlock resolution avoids the complete shutdown of the multi-robot system and the need for operator intervention as was required in the past.

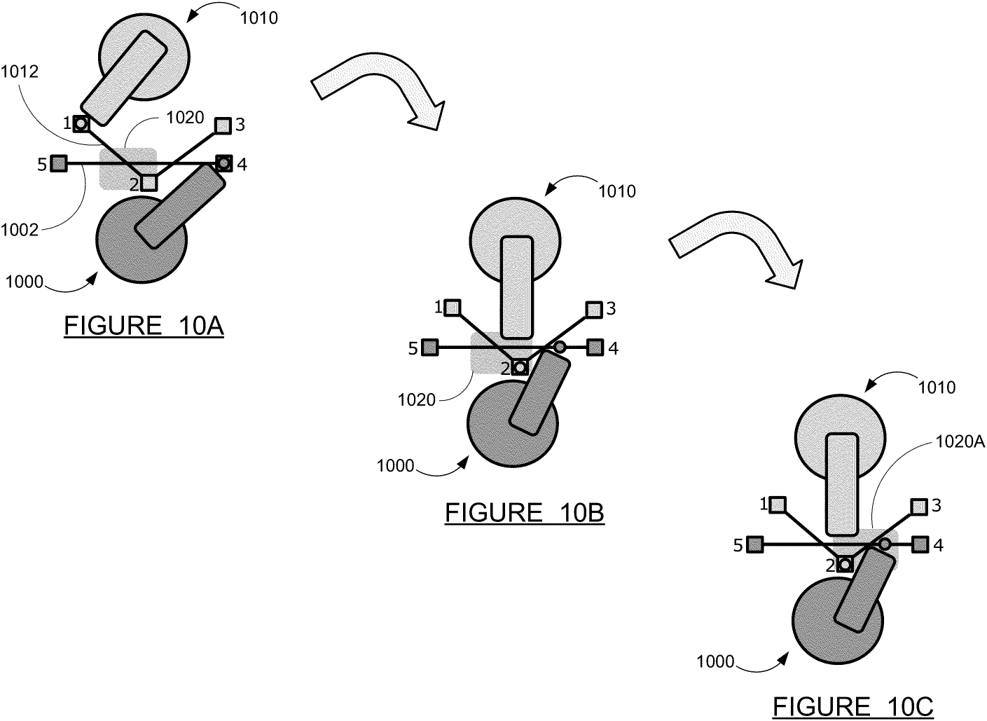

Some multi-robot systems include one or more robot which performs a continuous process operation, such as spray painting or laser/arc welding. These continuous process operations cannot be interrupted once they start, as the quality of the operation will suffer. This situation can be accommodated by adding further logic to the deadlock prevention methods and systems described above. In particular, it is possible to give priority to a continuous process operation which has started, such that other robots have the responsibility to hold position if necessary to avoid a deadlock condition. This is depicted in FIGS. 12-14.

FIG. 12 is a flowchart diagram of a method used by the motion planner in the controller of each robot which performs a continuous process operation in a multi-robot system, according to an embodiment of the present disclosure. The purpose of the method of FIG. 12 is to compute a swept volume for the entirety of the process operation. At box 1202, the process motion is analyzed to find the start and end events. For example, a typical motion program might include a command “Weld On” or “Paint On” to turn on the process, and a similar command to turn off the process. With the start and end events in the motion program identified, at box 1204 a swept volume is computed for the entire motion of the process operation - which typically will include a plurality of motion segments. Adaptive motion events such as jumps typically do not appear within a process operation, so the computed swept volume should be accurate. At box 1206, the computed swept volume for the process operation is stored in memory of the robot controller.

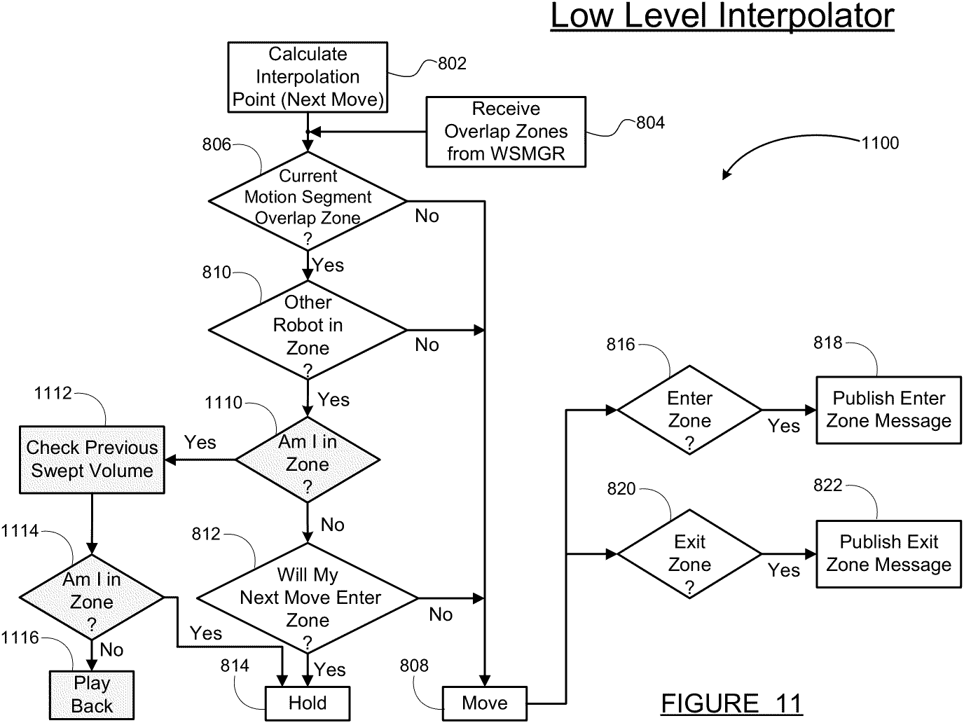

FIG. 13 is a flowchart diagram of a method used by the high level planner in the controller of each robot which performs a continuous process operation in a multi-robot system, according to an embodiment of the present disclosure. When a process start instruction is encountered during execution of the robot’s motion program, at box 1302 the process swept volume (computed and stored in FIG. 12) is published by the robot’s high level planner. At decision diamond 1304, it is determined if any other robot is in any overlap zone which involves the process swept volume. If so, the robot continues to loop at the decision diamond 1304 until the other robot has vacated the overlap zone. At box 1306, when the overlap zone has been vacated, the robot starts the process (e.g., starts spray painting). At box 1308, the robot publishes an “entered zone” message to the workspace manager. With the process swept volume published and the related overlap zone now entered by the robot, other robots in the system will remain clear of the overlap zone and the robot can complete the process operation without risk of deadlock.

When a process end instruction is encountered, at box 1310 the robot notifies the workspace manager that the process swept volume has been completed and can be removed. At box 1312, the robot ends the process (e.g., stops spray painting). At box 1314, the robot publishes an “exited zone” message to the workspace manager. With the process swept volume removed and the related overlap zone now exited by the robot, all of the robots in the system resume using the deadlock avoidance methods (online swept volume check & playback) described earlier.

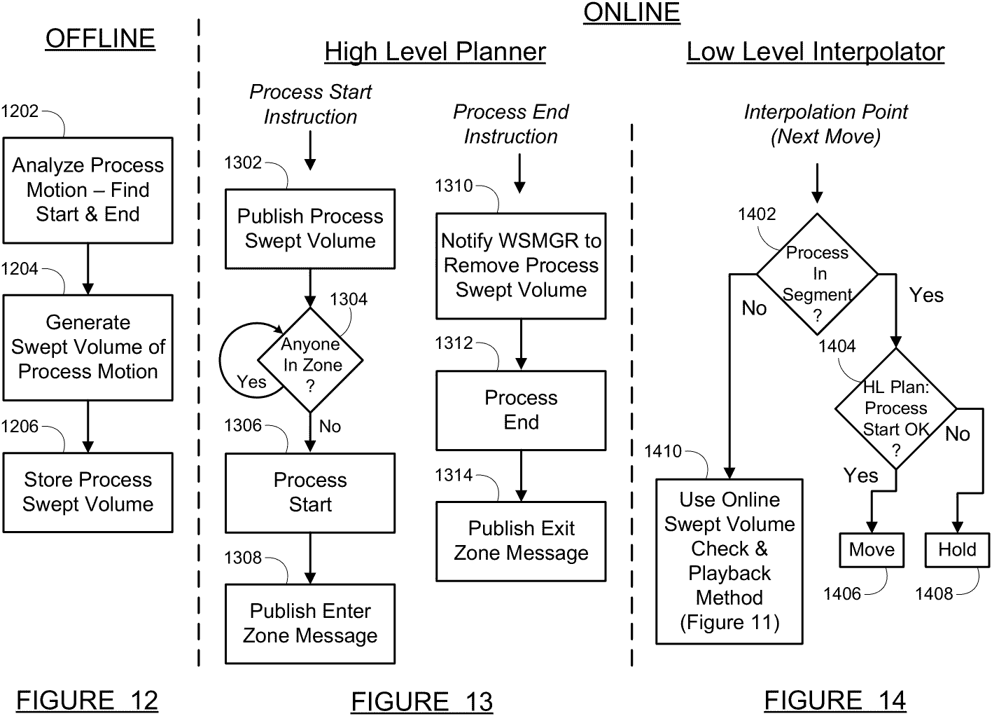

FIG. 14 is a flowchart diagram of a method used by the low level interpolator in the controller of each robot which performs a continuous process operation in a multi-robot system, according to an embodiment of the present disclosure. When an interpolation point is computed for a next move of the robot, at decision diamond 1402 it is determined whether there is a process operation in the current motion segment. If so, then at decision diamond 1404 the low level interpolator checks with the high level planner (of the same robot controller) to determine if the swept volume for the entire motion of the process has been published and it is ok to start the process. That is, if the box 1306 of FIG. 13 has been reached, then at the decision diamond 1404 the high level planner tells the low level interpolator that it is ok to start the process, and the low level interpolator tells the robot to move to the next interpolation point at box 1406. Once the process operation has started, the robot will continue to give itself clearance to move to each next interpolation point until the process ends.

If, at the decision diamond 1404, the high level planner tells the low level interpolator that it is not ok to start the process (e.g., the process swept volume has not yet been published, or the resultant overlap zone is occupied by another robot), and the low level interpolator tells the robot to hold position at box 1406. The robot will continue to hold position until receiving clearance from the high level planner to move into the process swept volume.

If it is determined at the decision diamond 1402 that there is no continuous process operation in the current motion segment, then at box 1410 the method for online swept volume publication, overlap zone checking and playback (FIG. 11, discussed above) is used.

It is noteworthy that the changes required to accommodate continuous process operations, depicted in the methods of FIGS. 12-14, are minimal, and do not require changing the data model of the overlap zone pool. It is not necessary to publish a notice of ongoing processing for other robots’ awareness. It is only necessary to publish a swept volume for the entire process, and publish zone entry/exit messages in the manner described earlier.

In all of the methods and systems disclosed hereinabove, the functions of the high level planner and the low level interpolator in the robot controller as described should be understood as one example implementation embodiment. Different robot controller designs may not divide the calculations, features and functions between a high level planner module and a low level interpolator module in this manner. As long as the robot controller performs the motion segment swept volume publication and the pre-movement checking to avoid entering an occupied overlap zone, the disclosed techniques will effectively prevent and/or resolve deadlock situations.

Throughout the preceding discussion, various computers and controllers are described and implied. It is to be understood that the software applications and modules of these computer and controllers are executed on one or more computing devices having a processor and a memory module. In particular, this includes a processor in each of the robot controllers 102 and 112, and the optional workcell controller 130, discussed above with respect to FIG. 1. Specifically, the processors in the robot controllers and the workcell controller are configured to perform the motion segment swept volume publication, overlap zone computation and publication, and pre-movement checking to avoid entering an occupied overlap zone, in the manner described throughout the foregoing disclosure. Furthermore, it is to be understood that an individual controller may be provided for each robot in a workcell, or one controller may be used to control the motion of more than one robot, as best suited to the application. In any case, there is a motion planner module which computes motions for each individual robot -including the high level planner and low level interpolator functions described hereinabove.

As outlined above, the disclosed techniques for deadlock avoidance in robot motion planning improve the robustness and reliability of deadlock prevention. The disclosed techniques avoid the up-front effort and inherent inaccuracy of manually defined interlocks for overlap zone avoidance, and enable automatic overlap zone avoidance interlocks to be added even in motion programs which include adaptive features such as jumps and position registers which are only computed during actual online robot operations.

While a number of exemplary aspects and embodiments of deadlock avoidance in robot motion planning have been discussed above, those of skill in the art will recognize modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. An online method for preventing deadlock in a multi-robot system including two or more robots operating in a common workspace, each robot being controlled by a controller including a processor and memory, said method comprising:
computing a swept volume for one or more upcoming motion segments, by a motion planner module in the controller for each of the robots;
publishing the swept volumes to a workspace manager module;
computing an overlap zone, by the workspace manager module, as a spatial volume of overlap between any two or more of the swept volumes from any two or more of the robots;
publishing each of the overlap zones and status data to the controllers of each of the robots involved in each of the overlap zones;
checking the overlap zones and the status data, by the motion planner module in the controller for each of the robots after computing a next increment of robot movement;
executing the next step of robot movement when the next increment will not cause the robot to enter an occupied overlap zone;
holding the robot in a current position when the next increment would cause the robot to enter an occupied overlap zone; and
notifying the workspace manager module, by the motion planner module in the controller for each of the robots, when an overlap zone is entered or exited.

2. The method according to claim 1 wherein the workspace manager module runs on one of the controllers or on a computer in communication with the controller for each of the robots.

3. The method according to claim 1 wherein computing a swept volume for one or more upcoming motion segments, and publishing the swept volumes, are performed continuously during robot operations.

4. The method according to claim 1 wherein computing a swept volume for one or more upcoming motion segments, and publishing the swept volumes, are performed only after it is determined that any adaptive commands in the motion segments are resolved, where the adaptive commands include one or more of jumps and position register offsets.

5. The method according to claim 1 further comprising notifying the workspace manager module, by the motion planner module in the controller for each of the robots, when one of the swept volume’s motion segment has been completed.

6. The method according to claim 1 wherein the status data for each of the overlap zones includes the spatial volume of overlap, a motion segment number for each of the swept volumes included in the overlap zone, a list of the robots involved in the overlap zone, and an identity of any robot currently in the overlap zone.

7. The method according to claim 1 wherein publishing each of the overlap zones and the status data includes publishing each overlap zone when it is first created, re-publishing each overlap zone when any element of the status data changes, and publishing a cancellation of each overlap zone when it no longer exists.

8. The method according to claim 1 wherein the spatial volume of overlap for each of the overlap zones is computed using voxels to represent the swept volumes.

9. The method according to claim 1 further comprising, when the next increment would cause the robot to enter an occupied overlap zone, determining whether the robot is already in the occupied overlap zone, and if so, determining if the robot was in the occupied overlap zone for a previous motion segment swept volume.

10. The method according to claim 9 further comprising holding the robot in a current position when the robot was in the occupied overlap zone for the previous motion segment swept volume, and moving back to a previous increment when the robot was not in the occupied overlap zone for the previous motion segment swept volume.

11. The method according to claim 1 wherein the controllers are configured to give movement priority to any of the robots which are performing a continuous process operation, including spray painting, laser or arc welding, or dispensing a bead of material.

12. The method according to claim 11 wherein the motion planner module on the controller of the robot which is performing the continuous process operation computes and publishes a swept volume for the entire continuous process operation, then begins the continuous process operation when no overlap zone involving the swept volume for the entire continuous process operation is occupied.

13. An online method for preventing deadlock in a multi-robot system including two or more robots operating in a common workspace, each robot being controlled by a controller including a processor and memory, said method comprising:
computing a swept volume for one or more upcoming motion segments, by a motion planner module in the controller for each of the robots, where computing the swept volume is performed continuously during robot operations only after it is determined that any adaptive commands in the motion segments are resolved, where the adaptive commands include one or more of jumps and position register offsets;
publishing the swept volumes to a workspace manager module;
computing an overlap zone, by the workspace manager module, as a spatial volume of overlap between any two or more of the swept volumes from any two or more of the robots;
publishing each of the overlap zones and status data to the controllers of each of the robots involved in each of the overlap zones, where the status data for each of the overlap zones includes the spatial volume of overlap, a motion segment number for each of the swept volumes included in the overlap zone, a list of the robots involved in the overlap zone, and an identity of any robot currently in the overlap zone;
checking the overlap zones and the status data, by the motion planner module in the controller for each of the robots after computing a next step of robot movement;
executing the next step of robot movement when the next step will not cause the robot to enter an occupied overlap zone;
holding the robot in a current position when the next step would cause the robot to enter an occupied overlap zone;
notifying the workspace manager module, by the motion planner module in the controller for each of the robots, when an overlap zone is entered or exited; and
notifying the workspace manager module, by the motion planner module in the controller for each of the robots, when one of the swept volume’s motion segment has been completed.

14. A multi-robot system with online deadlock prevention, said system comprising:
two or more robots operating in a common workspace;
one or more controller controlling the two or more robots, each controller including a processor and memory;
a motion planner software module running on the controller for each of the robots; and
a workspace manager software module in communication with the motion planner software module on the controller for each of the robots,
where the motion planner software module on the controller for each of the robots is configured to;
compute a swept volume for one or more upcoming motion segments and publish the swept volumes to the workspace manager module,
and where the workspace manager software module is configured to;
compute an overlap zone as a spatial volume of overlap between any two or more of the swept volumes from any two or more of the robots,
publish each of the overlap zones and status data to the controllers of each of the robots involved in each of the overlap zones;
and where the motion planner software module on the controller for each of the robots is further configured to;
check the overlap zones and the status data after computing a next increment of robot movement,
execute the next increment of robot movement when the next increment will not cause the robot to enter an occupied overlap zone,
hold the robot in a current position when the next increment would cause the robot to enter an occupied overlap zone, and
notify the workspace manager software module when an overlap zone is entered or exited.

15. The system according to claim 14 wherein the workspace manager software module runs on one of the controllers or on a computer in communication with each of the controllers.

16. The system according to claim 14 wherein the motion planner software module computes and publishes the swept volume for one or more upcoming motion segments continuously during robot operations.

17. The system according to claim 14 wherein the motion planner software module computes a swept volume for one or more upcoming motion segments, and publishes the swept volumes, only after it is determined that any adaptive commands in the motion segments are resolved, where the adaptive commands include one or more of jumps and position register offsets.

18. The system according to claim 14 wherein the motion planner software module is further configured to notify the workspace manager software module when one of the swept volume’s motion segment has been completed.

19. The system according to claim 14 wherein the status data for each of the overlap zones includes the spatial volume of overlap, a motion segment number for each of the swept volumes included in the overlap zone, a list of the robots involved in the overlap zone, and an identity of any robot currently in the overlap zone.

20. The system according to claim 14 wherein the workspace manager software module publishes each of the overlap zones and the status data when each overlap zone is first created, re-publishes each overlap zone and the status data when any element of the status data changes, and publishes a cancellation of each overlap zone when it no longer exists.

21. The system according to claim 14 the motion planner software module is further configured to determine, when the next increment would cause the robot to enter an occupied overlap zone, whether the robot is already in the occupied overlap zone, and if so, determine if the robot was in the occupied overlap zone for a previous motion segment swept volume.

22. The system according to claim 21 the motion planner software module is further configured to hold the robot in a current position when the robot was in the occupied overlap zone for the previous motion segment swept volume, and move the robot back to a previous increment when the robot was not in the occupied overlap zone for the previous motion segment swept volume.

23. The system according to claim 14 wherein the motion planner software module on the controller of a robot which is ready to begin a continuous process operation computes and publishes a swept volume for all motion segments in the continuous process operation, then begins the continuous process operation when no overlap zone involving the swept volume for the entire continuous process operation is occupied.

24. The system according to claim 14 wherein checking the overlap zones and the status data after computing a next increment of robot movement, and actions taken subsequent to checking the overlap zones, are implemented as interlocks in motion programs executed by the motion planner software module on the controller for each of the robots.
